(19) United States
(12) Patent Application Publication
(10) Pub. No.: US 2017/0059918 A1
(43) Pub. Date: Mar. 2, 2017

(54) DISPLAY DEVICE

(71) Applicant: Japan Display Inc., Tokyo (JP)

(72) Inventors: Toshinari SASAKI, Tokyo (JP); Isao SUZUMURA, Tokyo (JP); Shinichiro OKA, Tokyo (JP); Takuma NISHINOHARA, Tokyo (JP)

(21) Appl. No.: 15/234,090

(22) Filed: Aug. 11, 2016

(30) Foreign Application Priority Data
Aug. 24, 2015 (JP) 2015-164420

(51) Int. Cl. G02F 1/1333; G02F 1/1341; G02F 1/1339

(52) U.S. Cl. CPC G02F 1/133345; G02F 1/133305; G02F 1/13394; G02F 1/1341; G02F 2202/022

(57) ABSTRACT

A display device includes a first resin substrate; a second resin substrate facing the first. resin substrate; a liquid crystal layer held between the first resin substrate and the second resin substrate; a first insulating film located between the first resin substrate and the liquid crystal layer; a second insulating film located between the first insulating film and the liquid crystal layer, the second insulating film having a compressive stress; a third insulating film located between the second resin substrate and the liquid crystal layer; a fourth insulating film located between the second insulating film. and the liquid crystal layer, the fourth insulating film having a compressive stress; and a plurality of spacers located between the first resin substrate and the second resin substrate, the plurality of spacers defining an interval between the first resin substrate and the second resin substrate.

### CROSS REFERENCE TO RELATED APPLICATIONS

This application is based upon and claims the benefit of priority from the prior Japanese Patent Application No. 2015-164420 filed on Aug. 24, 2015, the entire contents of which are incorporated herein by reference.

### FIELD The present invention relates to a display device, and specifically to a structure of a substrate of a flexible display device.

### BACKGROUND

A liquid crystal display device includes a TFT substrate including a pixel electrode and a transistor included in each of a plurality of pixels arrayed in rows by columns, a color filter (CF) substrate, and a liquid crystal layer held between the TFT substrate and the CF substrate. The pixel electrode provided in each pixel is supplied with a voltage in correspondence with a gray scale, whereas a common. electrode provided for the plurality of pixels is supplied with a voltage common to the plurality of pixels. Alignment of liquid crystal molecules is changed by an electric field generated by the voltage applied to each of the pixel electrodes and the voltage applied to the common electrode, and thus the polarization direction of light incident on the liquid crystal layer is changed.

Especially, among the liquid crystal display devices, flexible display devices including a thin substrate formed of a resin such as polyimide (PI) or the like have been actively developed recently. Such a flexible display device is produced as follows. A TFT substrate is prepared. The TFT substrate includes a resin substrate formed of a PI film or the like provided on a support substrate formed of glass or the like, and thin film transistor circuit elements and liquid crystal capacitances that are provided sequentially on the resin substrate. Separately, a CF substrate is prepared. The CF substrate includes a resin substrate formed of a PI film or the like provided on another support substrate, and color filters provided on the resin substrate. The TFT substrate and the CF substrate are assembled together, and the support substrates are peeled off. The resultant assembly is divided into a plurality of individual display devices. Thus, a flexible display device including a thin PI resin substrate is produced.

A liquid crystal display device needs to have an interval between the TFT substrate and the CF substrate (namely, a cell gap) maintained at a certain distance. Otherwise, image quality provided by the liquid crystal display device is decreased. Especially in a flexible liquid crystal display device, both of the TFT substrate and the CF substrate are formed of a flexible material. Therefore, it is difficult to maintain the cell gap at a certain distance, and thus high image quality is not provided.

In order to solve this problem, for example, Japanese Laid-Open Patent Publication No. 2013-125261 discloses a liquid crystal display device that includes plastic substrates and thus is capable of displaying an image on a curved surface. In a central part. of a display region of the liquid crystal display device, spacers are located densely, more specifically, at a pitch of 100 μm or shorter. By contrast, in both of two end parts of the display region in a direction in which the liquid crystal display device is to be bent, the spacers are provided sparsely, more specifically, at a pitch of 200 μm or longer.

However, even such a structure in the conventional art does not allow the cell gap to be maintained easily at a certain distance if a force is generated in such a direction as to increase the cell gap and the cell gap exceeds the height of the spaces, unless both of two ends of the spacers are adhesive.

### SUMMARY

An embodiment of the present invention is directed to a display device including a first resin substrate; a second resin substrate facing the first resin substrate; a liquid crystal layer held between the first resin substrate and the second resin substrate; a first insulating film located between the first resin substrate and the liquid crystal layer; a second insulating film located between the first insulating film and the liquid crystal layer, the second insulating film having a compressive stress; a third insulating film located between the second resin substrate and the liquid crystal layer; a fourth insulating film located between the third insulating film and the liquid crystal layer, the fourth insulating film having a compressive stress; and a plurality of spacers located between the first resin substrate and the second resin substrate, the plurality of spacers defining an interval between the first resin substrate and the second resin substrate.

An embodiment of the present invention is directed. to a method for producing a display device including forming a flexible first resin substrate on a first support substrate; forming a first insulating film on the first resin substrate by sputtering at room temperature; forming a second insulating film having a compressive stress on the first insulating film; forming a flexible second resin substrate on a second support substrate; forming a third insulating film on the second. resin substrate by sputtering at room temperature; forming a fourth insulating film having a compressive stress on the third insulating film; and assembling the first resin substrate and the second resin substrate with a plurality of spacers being located therebetween, the plurality of spacers defining an interval between the first resin substrate and the second resin substrate.

### BRIEF DESCRIPTION OF DRAWINGS

FIG. 1 is a schematic view showing a structure of a display device in an embodiment according to the present invention;

FIG. 2 is a cross-sectional view showing the structure of the display device in the embodiment;

FIG. 3 is a schematic view showing that a first resin substrate and a second resin substrate are warped after being peeled off from support substrates;

FIG. 4A provides cross-sectional views showing a method for producing the display device in the embodiment;

FIG. 4B provides cross-sectional views showing a method for producing the display device in the embodiment;

FIG. 4C provides cross-sectional views showing a method for producing the display device in the embodiment;

FIG. 4D provides cross-sectional views showing a method for producing the display device in the embodiment;

FIG. 5A provides cross-sectional views showing the method for producing the display device in the embodiment;

FIG. 5B provides cross-sectional views showing the method for producing the display device in the embodiment;

FIG. 5C provides cross-sectional views showing the method for producing the display device in the embodiment;

FIG. 5D provides cross-sectional views showing a method for producing the display device in the embodiment;

FIG. 6A provides cross-sectional views showing the method for producing the display device in the embodiment;

FIG. 6B provides cross-sectional views showing the method for producing the display device in the embodiment;

FIG. 6C provides cross-sectional views showing the method for producing the display device in the embodiment;

FIG. 6D provides cross-sectional views showing the method for producing the display device in the embodiment.;

FIG. 6E provides cross-sectional views showing the method for producing the display device in the embodiment;

FIG. 6F provides cross-sectional views showing the method for producing the display device in the embodiment;

FIG. 6G provides cross-sectional views showing the method for producing the display device in the embodiment;

FIG. 6H provides cross-sectional views showing the method. for producing the display device in the embodiment; and

FIG. 7 is a cross-sectional view showing a structure of a display device in another embodiment according to the present invention.

### DESCRIPTION OF EMBODIMENTS

Hereinafter, embodiments of the present invention will be described with reference to the drawings and the like. The present invention may be carried out in various other embodiments, and should not be construed as being limited to any of the following embodiments. In the drawings, components may be shown schematically regarding the width, thickness, shape and the like, instead of being shown in accordance with the actual sizes, for the sake of clear illustration. The drawings are merely exemplary and do not limit the interpretations of the present invention in any way. In the specification and the drawings, components that are substantially the same as those shown in a previous drawing(s) bear the identical reference signs thereto, and detailed descriptions thereof may be omitted.

In this specification, an expression that a component or area is “on” another component or area encompasses a case where such a component or area is in contact with the another component or area and also a case where such a component or area is above or below the another component or area, namely, a case where still another component or area provided between such a component or area and the another component or area, unless otherwise specified.

### EMBODIMENT 1

### [Structure]

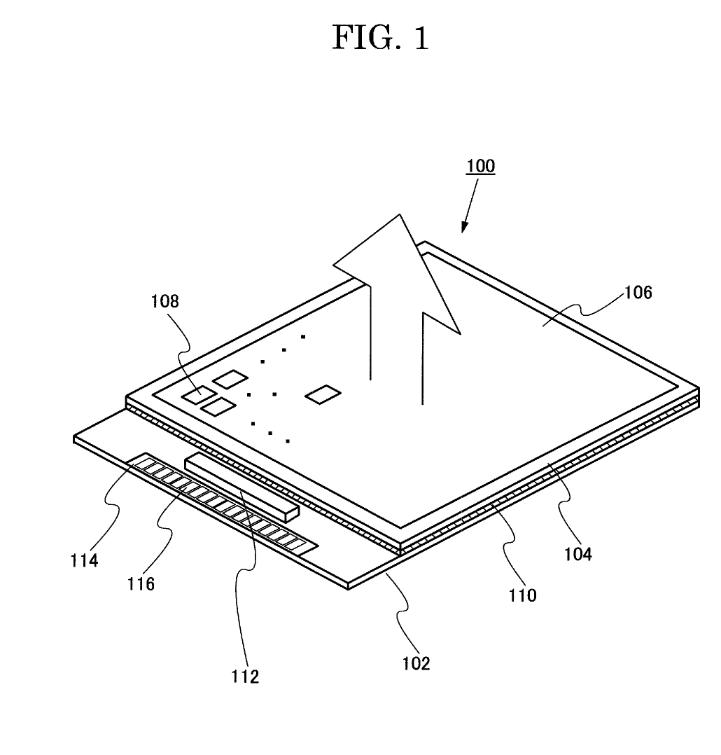

With reference to FIG. 1, a structure of a display device 100 in this embodiment will be described. FIG. 1 is a perspective view showing the structure of the display device 100 in this embodiment. The display device 100 in this embodiment. includes a first resin substrate 102, a second resin substrate 104, a plurality of pixels 108, a sealing member 110, a driver IC 112, and a terminal region 114. The terminal region 114 includes a plurality of connection terminals 116.

The first resin substrate 102 has a display region 106 provided thereon. The display region 106 includes an array of the plurality of pixels 108. On a top surface of the first resin substrate 102, the second resin substrate 104 is provided as a sealing member. The second resin substrate 104 is secured to the first resin substrate 102 by the sealing member 110 enclosing the display region 106. The display region 106 provided on the first resin substrate 102 is sealed by the second resin substrate 104 acting as the sealing member and the sealing member 110 so as not to be exposed to air. Such a sealing structure suppresses light emitting elements provided in the pixels 108 from being deteriorated.

The first resin substrate 102 has the terminal region 114 provided thereon along an end thereof. The terminal region 114 is located in a region outer to the second resin substrate 104. The terminal region 114 includes the plurality of connection terminals 116. At the connection terminals 116, a wiring board that connects a device outputting a video signal, a power supply or the like with a display panel is provided. A contact of the connection terminals 116 with the wiring board is exposed outside. The first resin substrate 102 has the driver IC 112 provided thereon. The driver IC 112 outputs a video signal, input from the terminal region 114, to the display region 106.

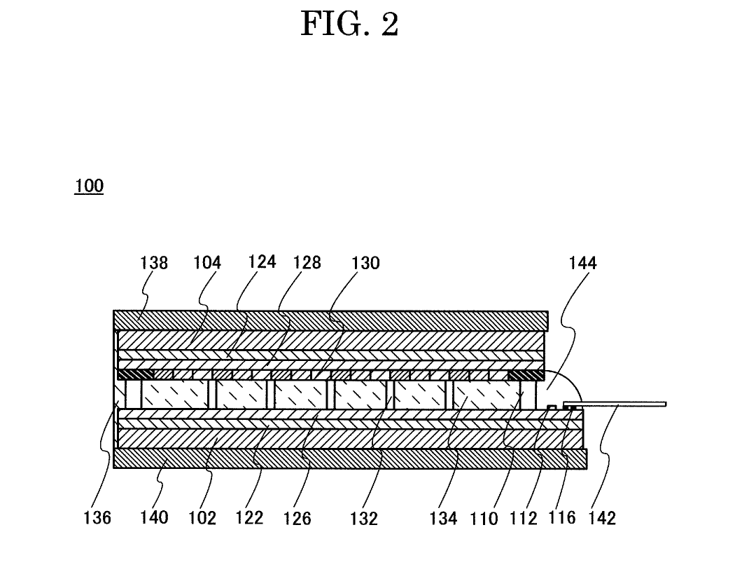

With reference to FIG. 2, the structure of the display device 100 in this embodiment will be described in detail. FIG. 2 is a cross-sectional view showing the structure of the display device 100 in this embodiment.

As shown in FIG. 2, the display device 100 in this embodiment includes the first resin substrate 102, the second resin substrate 104, a liquid crystal layer 134, a first insulating film 122, a second insulating film 126, a third insulating film 124, a fourth insulating film 128, and a plurality of spacers 132.

The second resin substrate 104 is located to face the first resin substrate 102. The liquid crystal layer 134 is held between the first resin substrate 102 and the second resin substrate 104. The first insulating film 122 is located between the first resin substrate 102 and the liquid crystal layer 134. The second insulating film 126 is located between the first insulating film 122 and the liquid crystal layer 134. The third insulating film 124 is located between the second resin substrate 104 and the liquid crystal layer 134. The fourth insulating film 128 is located between the third insulating film 124 and the liquid crystal layer 134. The plurality of spacers 132 are located between the first resin substrate 102 and the second resin substrate 104.

The second insulating film 126 and the fourth insulating film 128 each have a compressive stress. The plurality of spacers 132 are provided to define an interval between the first resin substrate 102 and the second resin substrate 104.

Such a structure of the display device 100 causes the first resin substrate 102 and the second resin substrate 104 to have a force pressing the liquid crystal layer 134 held between the first resin substrate 102 and the second resin substrate 104. More specifically, the first resin substrate 102 is caused to have a force pressing the liquid crystal layer 134 toward the second resin substrate 104, and the second resin substrate 104 is caused to have a force pressing the liquid. crystal layer 134 toward the first resin substrate 102. The pressing force thus generated is applied to the plurality of spacers 132 located between the first resin substrate 102 and the second resin substrate 104. There is no adhesive force between the plurality of spacers 132 and each of the first resin substrate 102 and the second resin substrate 104. However, the force pressing the plurality of spacers 132 allows the interval between the first. resin substrate 102 and the second resin substrate 104, namely, the cell gap, to maintained at a certain distance stably.

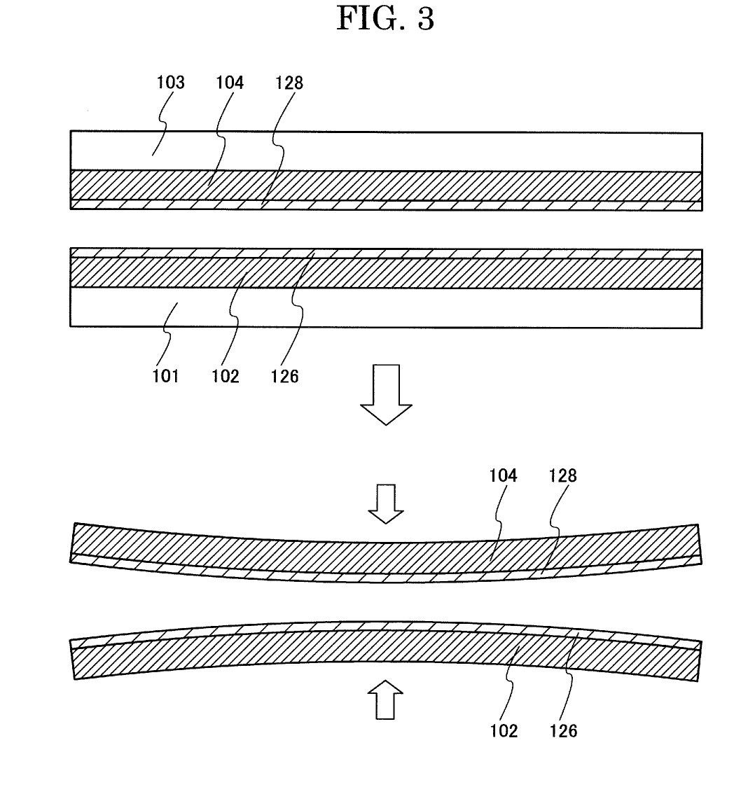

With reference to FIG. 3, a reason why the force pressing the liquid crystal layer 134 held between the first resin substrate 102 and the second resin substrate 104 is generated will be further described. FIG. 3 is a schematic view showing that the first resin substrate 102 and the second resin substrate 104 are warped after being peeled off from support substrates in a manufacturing process described below. In this figure, the first insulating film 122 and the third insulating film 124 are omitted. The second insulating film 126 located on the first resin substrate 102 and having a compressive stress has a stress causing the second insulating film 126 to extend in a planar direction. Unless the first resin substrate 102 and the first insulating film 122 below the second insulating film 126 have an internal stress as a whole, the compressive stress of the second insulating film 126 dominates the warping amount of the first resin substrate 102 and thus the first resin substrate 102 is warped as shown in FIG. 3. This is also applicable to the second resin substrate 104. In this specification, an assembly including the first resin substrate 102, a film provided thereon in contact with the liquid crystal layer 134 and the films provided therebetween will be referred to as a “TFT substrate”.

An assembly including the second resin substrate 104, a film provided thereon in contact with the liquid crystal layer 134 and the films provided therebetween will be referred to as a “CF substrate”. The above-described warp of the first resin substrate 102 and the second resin substrate 104 generates a force pressing the liquid crystal layer 134 held between the TFT substrate and the CF substrate when the TFT substrate and the CF substrate are assembled together while having the plurality of spacers 132 therebetween.

The first resin substrate 102 and the second resin substrate 104 may be formed of, for example, an organic resin. Alternatively, the first resin substrate 102 and the second resin substrate 104 may each have a stack structure including a plurality of types of organic resins. An example of the usable organic resin is polyimide (PI). In this embodiment, the first resin substrate 102 and the second resin substrate 104 are each a substrate containing polyimide.

The first insulating film 122 and the third insulating film 124 are formed by sputtering. The first insulating film 122 and the third insulating film 124 may be formed of an inorganic insulating material. Examples of the usable inorganic insulating material include silicon oxide (SiOx), silicon nitride (SiNx), silicon oxide nitride (SiOxNy) and the like. Alternatively, the first insulating film 122 and the third insulating film 124 may be formed of a material having a high dielectric constant (High-k) such as hafnium oxide (HfOx), zirconium oxide (ZrOx), aluminum oxide (AlOx), yttrium oxide (YOx), tungsten oxide (WOx) or the like. The first insulating film 122 and the third insulating film 124 may each have a stack structure including any of these materials. The first insulating film 122 and the third insulating film 124 may each be a sputtered insulating film formed by use of a sputtering target containing a mixture of any of these materials. Because of the method for forming, the first insulating film 122 and the third insulating film 124 are each an inorganic insulating film containing a higher content of argon (Ar) than each of the second insulating film 126 and the fourth insulating film 128. The first insulating film 122 and the third insulating film 124 each contain argon at a ratio of at least 0.1 at %.

Regarding the method for forming the first insulating film 122 and the third insulating film 124 on the respective resin substrates 102 and 104, sputtering allows the temperature, to which the substrate is to be heated, to be suppressed lower than CVD, or does not require the resin substrates 102 and 104 to be heated. Therefore, in the case where sputtering is used, the resin substrates are prevented from being thermally expanded or contracted. In general, a resin has a larger coefficient of thermal expansion (CTE value) than an inorganic material. Therefore, in the case where an insulating film is formed on a resin substrate under heating, there is a problem that the resin substrate is caused to have a large residual stress when being cooled to room temperature after the insulating film is formed.

The provision of the first insulating film 122 and the third insulating film 124 counteracts the stress caused to the first resin substrate 102 and the second resin substrate 104 by thermal expansion and contraction. Therefore, the second insulating film 126 and the fourth insulating film 128 having the compressive stress respectively determine the warping amounts of the TFT substrate and the CF substrate, and thus the cell gap is stably maintained at a certain distance. In addition, moisture is prevented from entering the TFT substrate and the liquid crystal layer 134. Thus, the display device 100 is made reliable.

Preferably, the first insulating film 122 and the third insulating film 124 have a high barrier property against moisture. Especially, a material having a higher dielectric constant (High-k) has a higher barrier property, and thus is more preferable.

The second insulating film 126 and the fourth insulating film 128 having a compressive stress may be formed of an inorganic insulating material. Examples of the usable inorganic insulating material include silicon oxide (SiOx), silicon nitride (SiNx), silicon oxide nitride (SiOxNy) and the like. Alternatively, the second insulating film 126 and the fourth insulating film 128 may each have a stack structure including any of these materials. A method for forming the second insulating film 126 and the fourth insulating film 128 will be described below. Plasma CVD is usable to form the second insulating film 126 and the fourth insulating film 128.

Preferably, the compressive stress of each of the second insulating film 126 and the fourth insulating film 128 has an absolute value of 200 MPa or greater. In the case where the second insulating film 126 and the fourth insulating film 128 have a stack structure, the absolute value of the compressive stress of the entire stack structure of each of the second insulating film 126 and the fourth insulating film 128 may be in the above-described range. If the compressive stress is smaller than the above-described range, neither the first resin substrate 102 nor the second resin substrate 104 is warped sufficiently, and thus it is difficult to maintain the cell gap at a certain distance stably. Namely, the cell gap may be undesirably increased by an external force easily to exceed the height of the plurality of spacers 132.

The display device 100 may include a gate insulating film, an interlayer insulating film, an organic flattening film, and the like provided on the second insulating film 126. These films need to have a compressive stress as a whole. Especially, the organic flattening film tends to have a tensile stress, and therefore, the compressive stress of the second insulating film 126 needs to counteract such a tensile stress. This is also applicable to the CF substrate.

It is preferable that the warping amounts of the second insulating film 126 and the fourth insulating film 128 are close to each other. It is also preferable that the absolute values of the compressive stress, and the thicknesses, of the second insulating film 126 and the fourth insulating film 128 are as close as possible to each other.

Preferably, the second insulating film 126 and the fourth insulating film 128 each have a thickness of 500 nm or greater. if the thickness is smaller than 500 nm, neither the second insulating film 126 or the fourth insulating film 128 is warped by an amount in the preferable range described above.

The second insulating film 126 does not need to be on the first insulating film 122 in contact with the first insulating film 122. It is sufficient that the second insulating film 126 is located above the first insulating film 122 in the TFT substrate. This is also applicable to the fourth insulating film 128.

For example, the second insulating film 126 may cover a plurality of transistors respectively located in the plurality of pixels 108, and a plurality of lines connected with the plurality of transistors via contact holes may be provided on the second insulating film 126.

In the case where the plurality of transistors respectively included in the plurality of pixels 108 are bottom gate-type transistors, the second insulating film 126 may be used as a gate insulating film of the plurality of transistors. The second insulating film 126 having a compressive stress is not limited to being the gate insulating film of the transistors, and may be used as an interlayer insulating film or an underlying insulating layer.

The display device 100 in this embodiment further includes a color filter (CF) layer 130 on the second resin substrate 104 on the side closer to the first resin substrate 102. The CF layer 130 includes a plurality of color filters respectively provided in the plurality of pixels 108 and a light blocking layer demarcating the color filters. Although not shown, the display device 100 may further include an overcoat layer covering the color filter layer 130.

The first resin substrate 102 and the second resin substrate 104 are assembled together with the sealing member 110. The liquid crystal layer 134 is held between the first resin substrate 102 and the second resin substrate 104 and is sealed by the sealing member 110.

The display device 100 may further include retardation film/polarization plates 138 and 140 respectively on the first resin substrate 102 and the second resin substrate 104.

The structure of the display device 100 in this embodiment is described above. In the display device 100 in this embodiment, the first resin substrate 102 and the second resin substrate 104 are caused to have a force pressing the liquid crystal layer 134. More specifically, the first resin substrate 102 is caused to have a force pressing the liquid crystal layer 134 toward the second resin substrate 104, and the second resin substrate 104 is caused to have a force pressing the liquid crystal layer 134 toward the first resin substrate 102. The pressing force thus generated is applied to the plurality of spacers 132 located between the first resin substrate 102 and the second resin substrate 104. Thus, the display device 100 maintains the interval between the first resin substrate 102 and the second resin. substrate 104, namely, the cell gap, at a certain distance stably by the plurality of spacers 132.

### [Manufacturing Method]

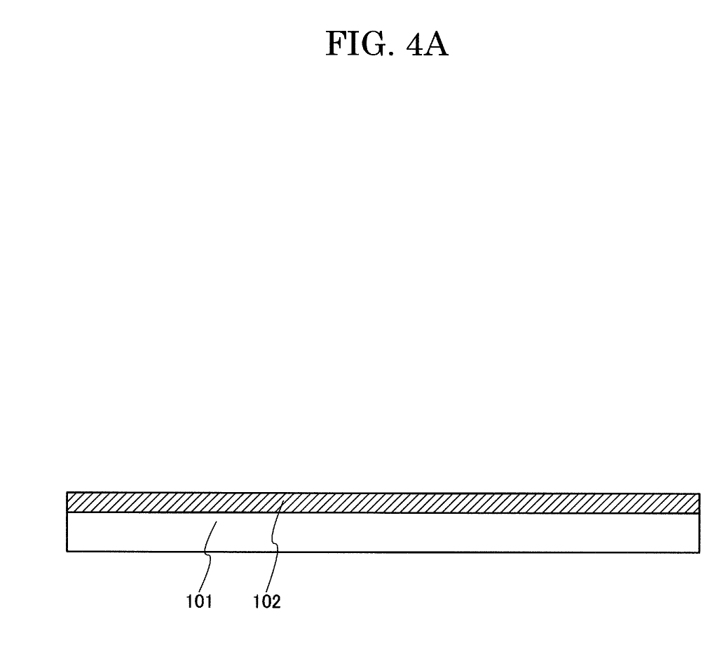

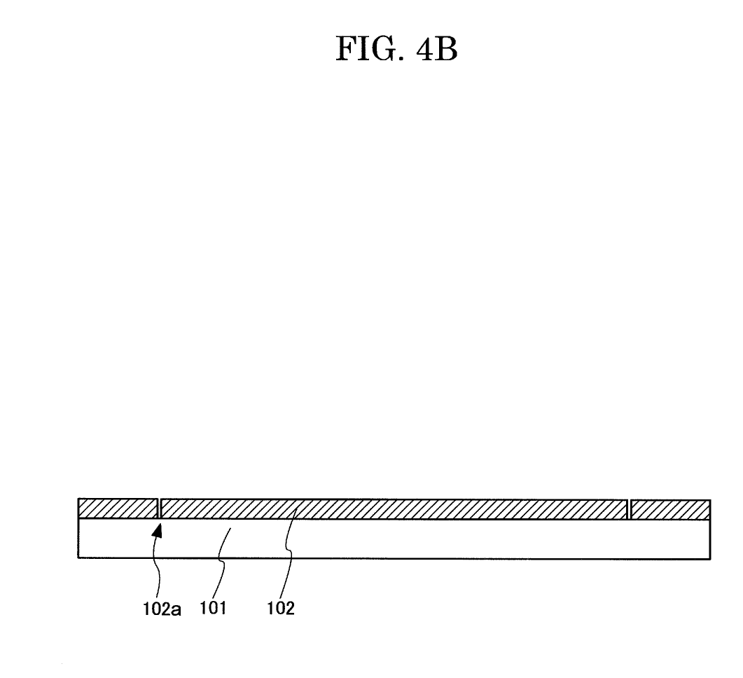

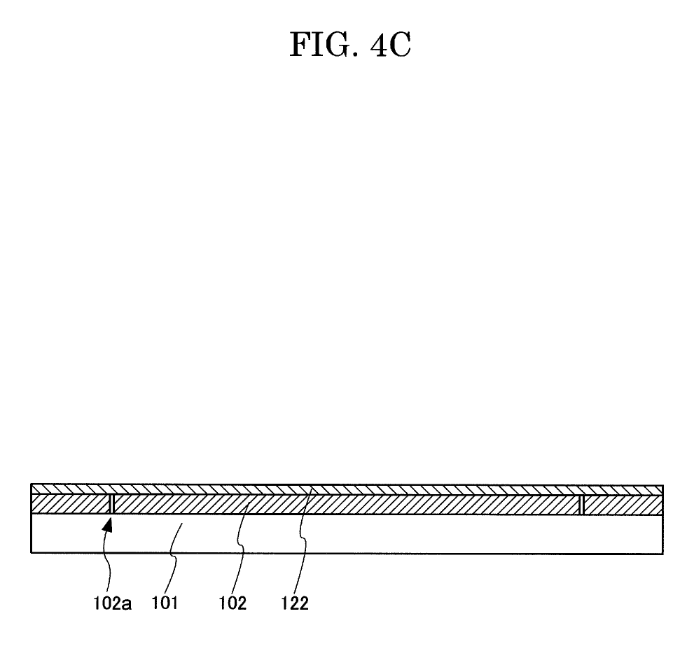

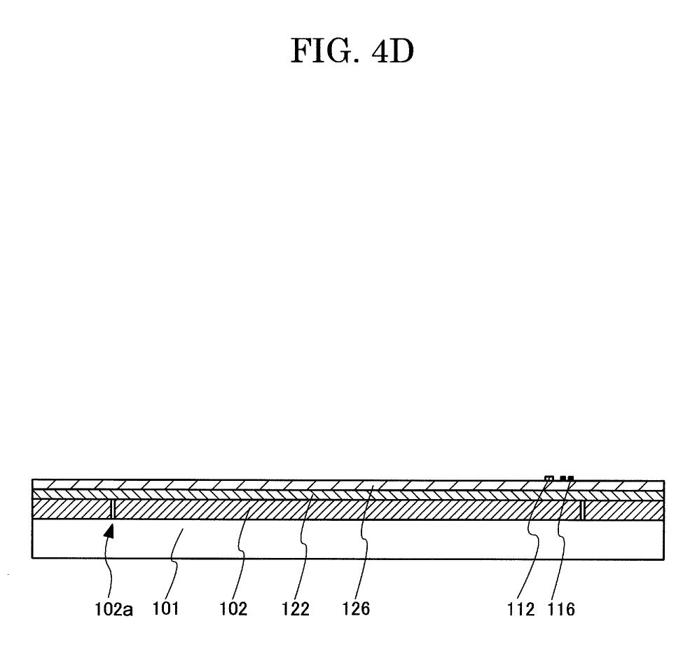

With reference to FIG. 4A through FIG. 6H, a method for producing the display device 100 in this embodiment will described in detail. FIG. 4A through FIG. 6H each provide cross-sectional views showing the method for producing the display device 100 in this embodiment.

First, a method for manufacturing the TFT substrate will be described. On a first support substrate 101, a material of the first resin substrate 102 is applied and baked to form the first resin substrate 102 having flexibility (FIG. 4A). The first resin substrate 102 may be formed of, for example, an organic resin. An example of the usable organic resin is polyimide. Alternatively, the first resin substrate 102 may have a stack structure including a plurality of types of organic resins. In this embodiment, the first resin substrate 102 is a substrate containing polyimide.

After the first resin substrate 102 is formed, a slit 102a may be formed by patterning in the first resin substrate 102 (FIG. 4B) around each of display devices 100 to be obtained individually in a later step as a result of division as described below. In the case where the first resin substrate 102 is formed of a photosensitive resin, the slit 102a may be formed by patterning by use of exposure and development. In the case where the first resin substrate 102 is not formed of a photosensitive resin, the slit 102a may be formed by patterning by dry etching or the like.

Next, on the first resin substrate 102, the first insulating film 122 is formed by sputtering at room temperature (FIG. 4C). The first insulating film 122 may be formed of an inorganic insulating material. Examples of the usable inorganic insulating material include silicon oxide (SiOx), silicon nitride (SiNx), silicon oxide nitride (SiOxNy) and the like. Alternatively, the first insulating film 122 may be formed of a material having a high dielectric constant (High-k) such as hafnium oxide (HfOx), zirconium oxide (ZrOx), aluminum oxide (AlOx), yttrium oxide (YOx), tungsten oxide (WOx) or the like. The first insulating film 122 may have a stack structure including any of these materials. The first insulating film 122 may be a sputtered insulating film formed by use of a sputtering target containing a mixture of any of these materials. Because of the method for forming, the first insulating film 122 is an inorganic insulating film containing a higher content of argon (Ar) than, for example, a film formed by CVD. The first insulating film 122 contains argon at a ratio of at least 0.1 at %. Alternatively, the first insulating film 122 may be formed by sputtering by use of noble gas such as neon (Ne), xenon (Xe) or the like. In the case where such noble gas is used, the first insulating film 122 is an inorganic insulating film containing a relatively high content of such an element.

Preferably, the first insulating film 122 is formed at room temperature. In the case where the first resin substrate 102 is formed of, for example, polyimide, if the first insulating film 122 is formed at a temperature higher than room temperature, polyimide is thermally expanded. When the temperature is cooled down to room temperature after the first insulating film 122 is formed, polyimide is thermally contracted. As a result, a stress is caused at an interface between the first resin substrate 102 and the first insulating film 122. This is caused because the coefficient of thermal expansion (CET value) of polyimide is larger than the CTE of the first insulating film 122. The CTE of polyimide, which depends on the composition ratio, may be about 5 to 40 ppm/° C. The CTE of SiOx, which is usable for the first insulating film 122, is about 0.5 ppm/° C., and the CTE of SiNx, which is also usable for the first insulating film 122, is about 2.5 ppm/° C.

Next, on the first insulating film 122, the second insulating film 126 having a compressive stress is formed (FIG. 4D). The second insulating film 126 having a compressive stress is formed under a condition that causes the absolute value of the compressive stress to be 200 MPa or greater. Preferably, the second insulating film 126 has a thickness of 500 nm or greater.

The second insulating film 126 having a compressive stress may be formed of an inorganic insulating material. Examples of the usable inorganic insulating material include silicon oxide (SiOx), silicon nitride (SiNx), silicon oxide nitride (SiOxNy) and the like.

The second insulating film 126 may be formed by plasma CVD. Especially, plasma CVD using silane (SiH4) gas and nitrogen monoxide (N2O) gas is usable for forming an insulating film having a compressive stress. The compressive stress may be controlled by controlling the flow rate of each type of gas and the electric power. For example, the compressive stress may be increased by decreasing the flow rate of the SiH4 gas or increasing the electric power.

Preferably, the compressive stress of the second insulating film 126 has an absolute value of 200 MPa or greater. If the absolute value of the compressive, stress of the second. insulating film 126 is smaller than this range, the first resin substrate 102 is not sufficiently warped and thus it is difficult to maintain the cell gas at a certain distance stably. Namely, the cell gap may be undesirably increased by an external force easily to exceed the height of the plurality of spacers 132.

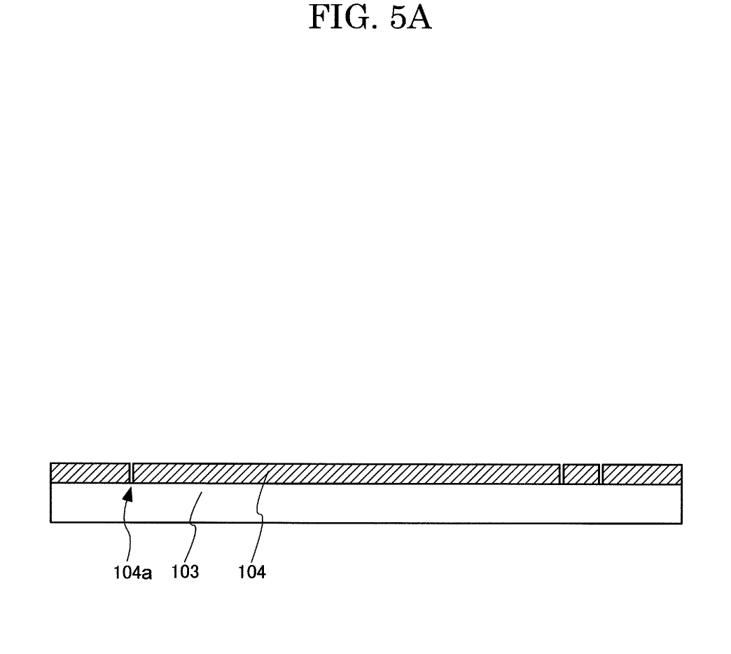

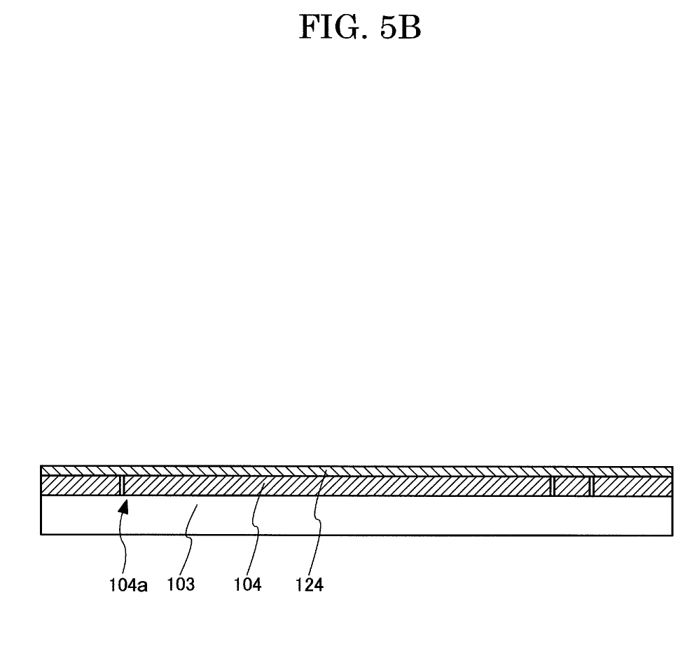

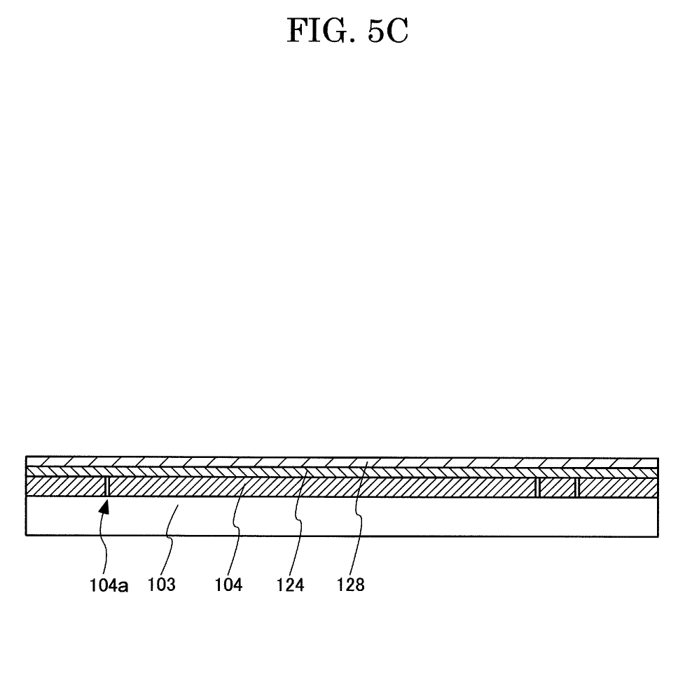

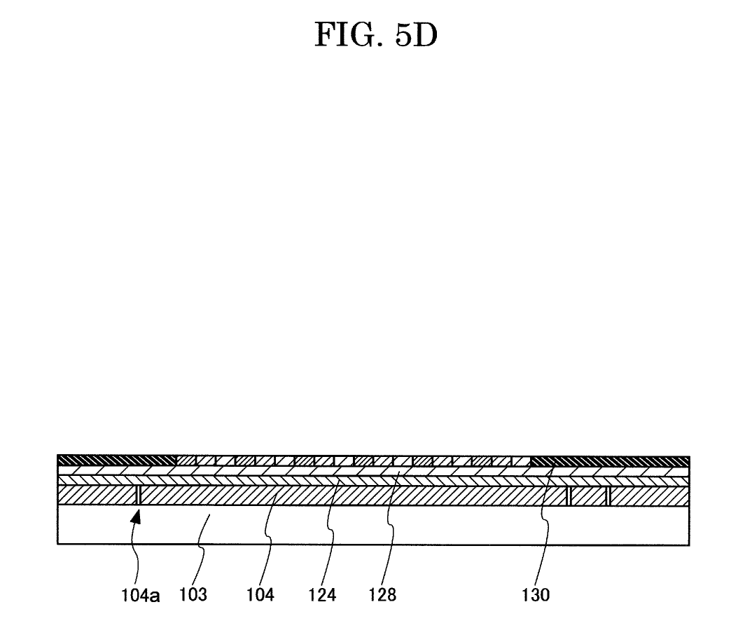

Next, a method for producing the CF substrate will be described. On a second support substrate 103, a material of the second resin substrate 104 is applied and baked to form the second resin substrate 104 having flexibility. The second resin substrate 104 may be formed of, for example, an organic resin. An example of the usable organic resin is polyimide. In this embodiment, the second resin substrate 104 is a substrate containing polyimide. After the second resin substrate 104 is formed, a slit 104a may be formed by patterning in the second resin substrate 104 (FIG. 5A) around each of display devices 100 to be obtained individually in a later step as a result of division as described below. The formation of the slit 104a is substantially the same as the formation of the slit 102a in the TFT substrate, and thus will not be described in detail.

Next, on the second resin substrate 104, the third insulating film 124 is formed by sputtering at room temperature (FIG. 5B). The formation of the third insulating film 124 is substantially the same as the formation of the first insulating film 122 in the TFT substrate, and thus will not be described in detail.

Next, on the third insulating film 124, the fourth insulating film 128 having a compressive stress is formed (FIG. 5C). The fourth insulating film 128 having a compressive stress is formed under a condition that causes the absolute value of the compressive stress to be 200 MPa or greater. Preferably, the fourth insulating film 128 has a thickness of 500 nm or greater. The formation of the fourth insulating film 128 is substantially the same as the formation of the second insulating film 126 in the TFT substrate, and thus will not be described in detail.

Next, on the fourth insulating film 128, the color filter (CF) layer 130 is formed (FIG. 5D). The CF layer 130 includes the plurality of color filters respectively provided in the plurality of pixels 108 and the light blocking layer demarcating the color filters. Although not shown, the overcoat layer may be formed so as to cover the color filter layer 130. The overcoat layer may be formed of an organic insulating material such as, for example, an acrylic resin or the like, or an inorganic insulating material such as, for example, silicon nitride or the like.

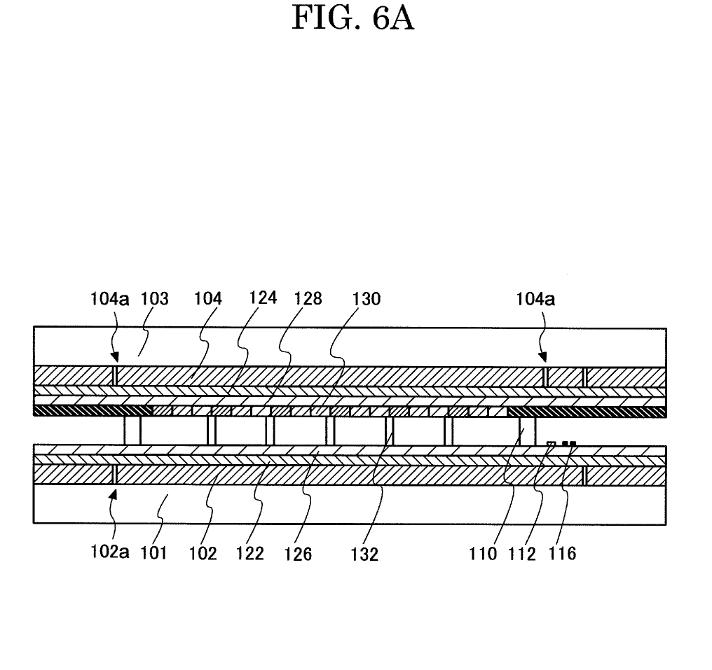

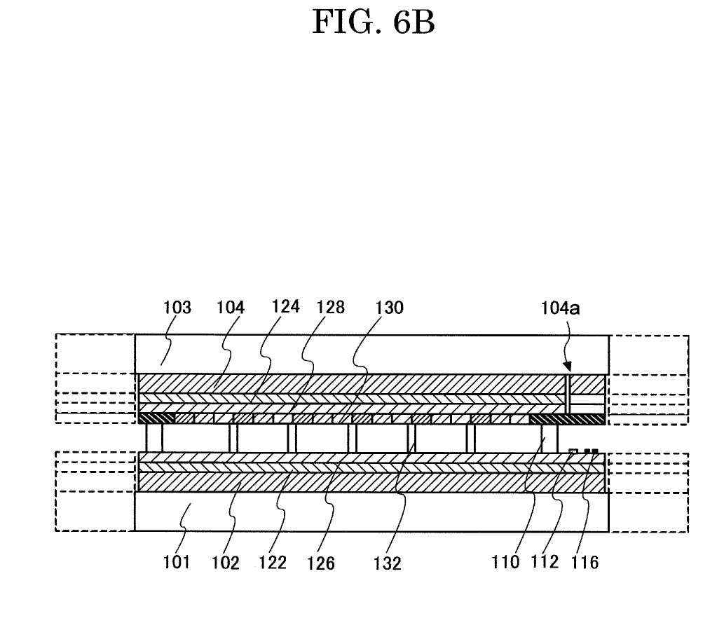

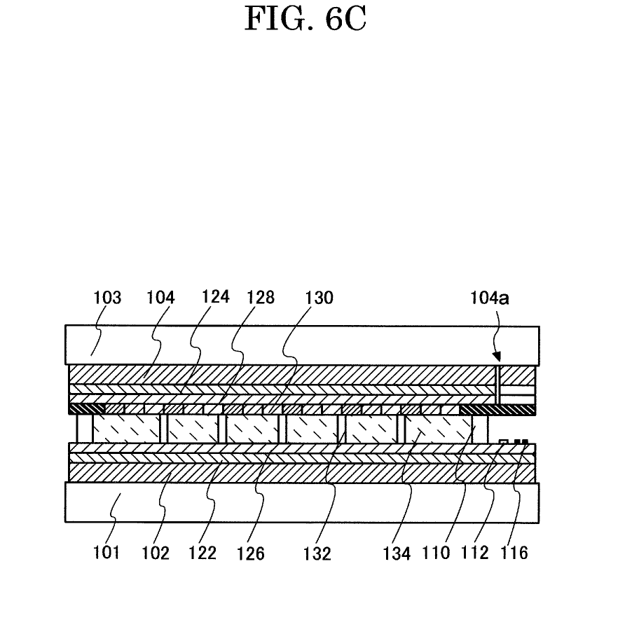

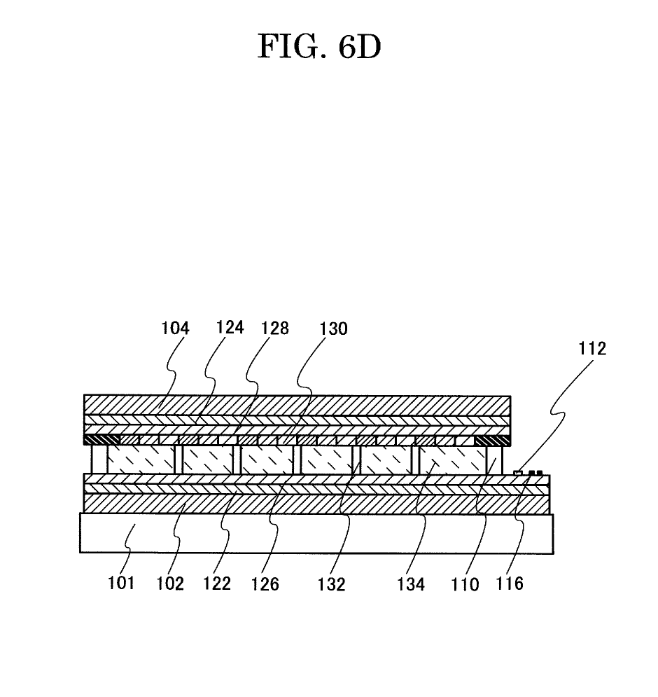

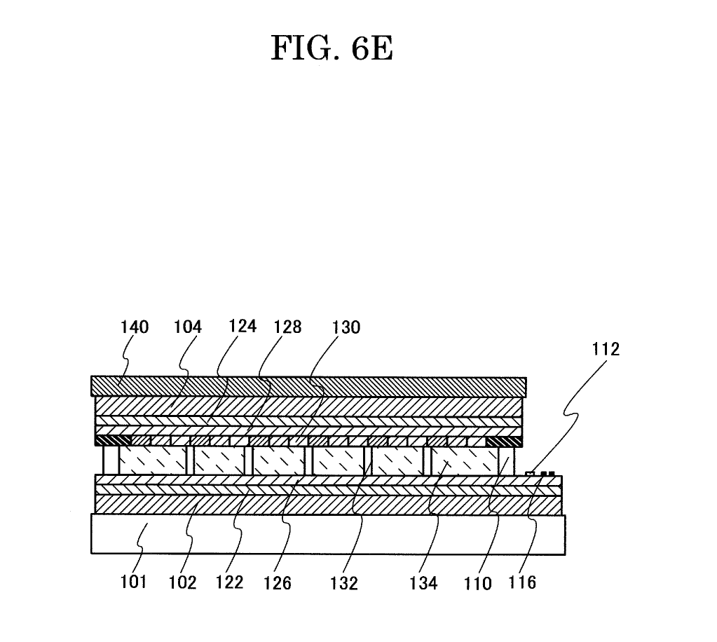

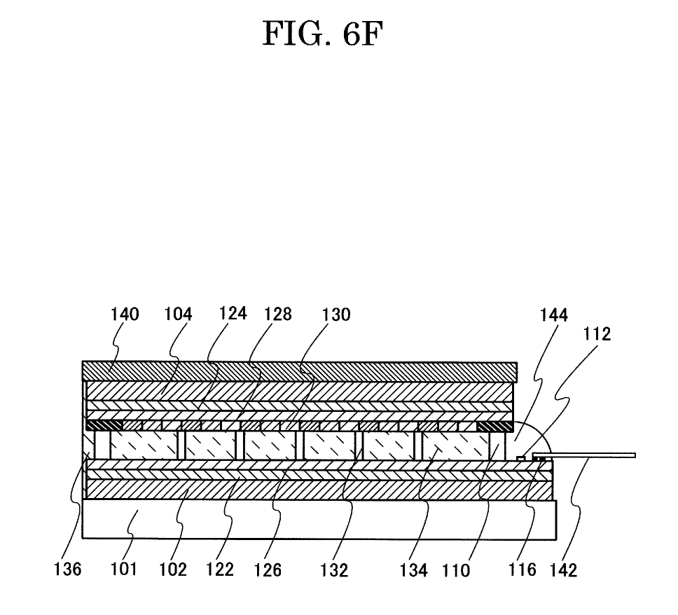

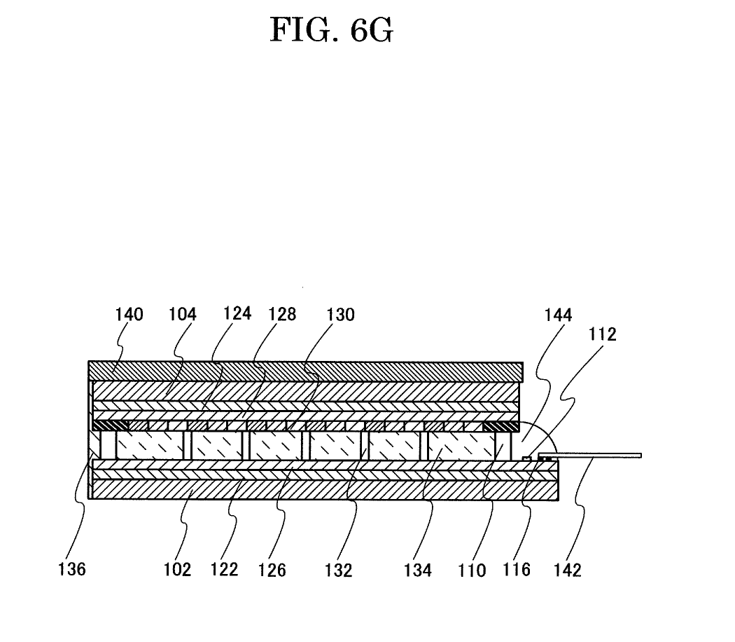

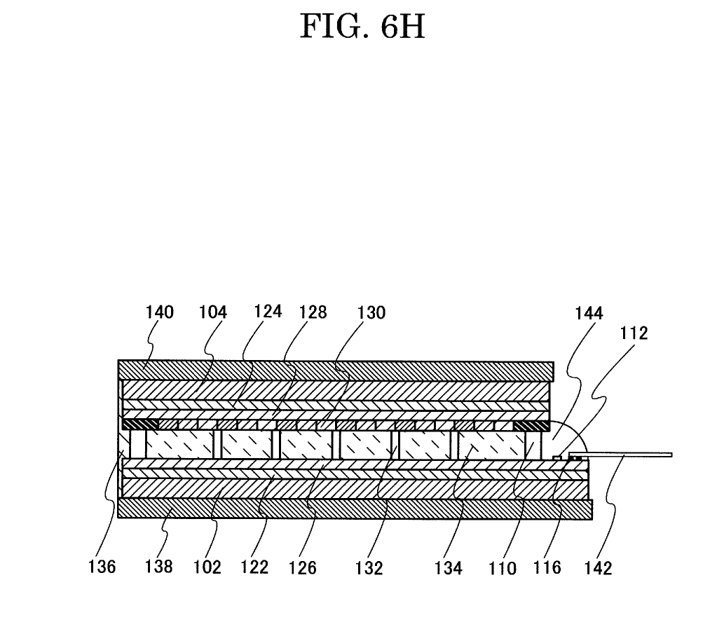

Now, assembly of the TFT substrate and the CF substrate and steps thereafter will be described. The first resin substrate 102 and the second resin substrate 104 are assembled together while having the plurality of spacers 132 therebetween (FIG. 6A). The plurality of spacers 132 define the interval between the first resin substrate 102 and the second resin substrate 104.

Next, the resultant assembly, more specifically, the assembly including the first and second support substrates 101 and 103 and the elements therebetween is divided into individual display devices (FIG. 6B). Before being assembled together, the first resin substrate 102 and the second resin substrate 104 respectively have the slits 102a and 104a formed therein around each of the individual display devices 100. Therefore, only the first support substrate 101 and the second support substrate 103 need to be cut along a line extending around each of the display devices 100, so that the individual display devices 100 are obtained. None of the first insulating film 122, the second insulating film 126, the third insulating film 124, the fourth insulating film 128 and the like has any slit formed therein before the first resin substrate 102 and the second resin substrate 104 are assembled together. However, these films are thin and thus are easily divided.

Next, a liquid crystal material is injected into a space between. the first resin. substrate 102 and the second resin substrate 104 to form the liquid crystal layer 134 (FIG. 6C). The liquid crystal layer 134 is sealed by the first resin substrate 102, the second resin substrate 104 and the sealing member 110.

Next, the second support substrate 103 is peeled off (FIG. 6D). The second support substrate 103 is peeled off as follows. The second support substrate 103 is subjected to energy radiation. As a result, the second resin substrate 104 is vaporized in the vicinity of an interface between the second support substrate 103 and the second resin substrate 104, and thus the adhesiveness between. the second support substrate 103 and the second resin substrate 104 is decreased. As a result, the second support substrate 103 peeled off. Energy radiation may be, for example, laser radiation. The laser radiation may be, for example, excimer laser radiation.

Together with the second support substrate 103, an area of the second resin substrate 104 that corresponds to the terminal region 114 on the first resin substrate 102 is also peeled off. A reason for this is that before the first resin substrate 102 and the second resin substrate 104 are assembled together, the second resin substrate 104 has the slit 104a also between an area thereof corresponding to the display region 106 and the area thereof corresponding to the terminal region 114.

After the second support substrate 103 is peeled off, the phase plate/polarization plate 140 may be assembled to the second resin substrate 104 (FIG. 6E).

Next, an FPC (Flexible Printed Circuit) 142 may be mounted on the connection. terminals 116 included in the terminal region 114. The driver IC 112 may be mounted on the first resin substrate 102. A protective member 144 may be located so as to cover the connection terminals 116 (FIG. 6F).

Next, the first support substrate 101 is peeled off (FIG. 6G). The method for peeling off the first support substrate 101 is substantially the same as that for the second support substrate 103 described above, and thus will not be described in detail.

After the first support substrate 101 is peeled off, the phase plate/polarization plate 138 may be assembled to the first resin substrate 102 (FIG. 6H). The display device 100 in this embodiment is produced by the method described above.

The method for producing the display device 100 in this embodiment is described above. With the method for producing the display device 100 in this embodiment, the first resin substrate 102 and the second resin substrate 104 are caused to have a force pressing the liquid crystal layer 134. More specifically, the first resin substrate 102 is caused to have a force pressing the liquid crystal layer 134 toward the second resin substrate 104, and the second resin substrate 104 is caused to have a force pressing the liquid crystal layer 134 toward the first resin substrate 102. The pressing force thus generated is applied to the plurality of spacers 132 located between the first resin substrate 102 and the second resin substrate 104. Thus, the display device 100 maintains the interval between the first resin substrate 102 and the second resin substrate 104, namely, the cell gap, at a certain distance stably by the plurality of spacers 132.

### Embodiment 2

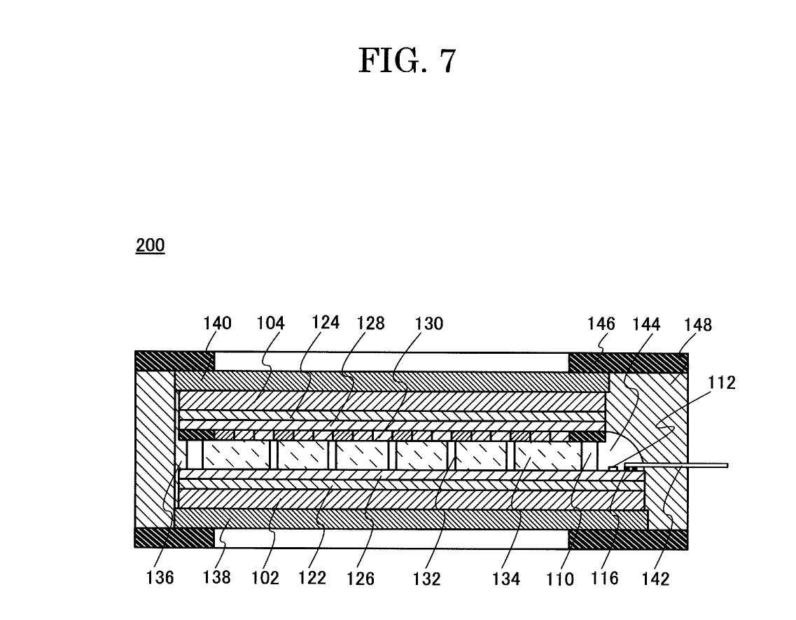

With reference to FIG. 7, a structure of a display device 200 in this embodiment will be described. FIG. 7 is a cross-sectional view showing the structure of the display device 200 in this embodiment.

Unlike the display device 100 in embodiment 1, the display device 200 in this embodiment includes a card substrate 146. A space in the display device 200 that is sealed by the card substrate 146 and is not included in the display region 106 is filled with a filler 148. In this manner, the display device 100 in embodiment 1. may be made into a card so as to provide the display device 200 in embodiment 2.

Some preferable embodiments of the present invention have been described in embodiments 1 and 2. These embodiments are merely examples, and the technological scope of the present invention is not limited to any of these embodiments. A person of ordinary skill in the art would. make various alterations without departing from the gist of the present invention. Therefore, such alterations are to be construed to be encompassed in the technological scope of the present invention.

What is claimed is:

1. A display device, comprising:
a first resin substrate;
a second resin substrate facing the first resin substrate;
a liquid crystal layer held between the first resin substrate and the second resin substrate;
a first insulating film located between the first resin substrate and the liquid crystal layer;
a second insulating film located between the first insulating film and the liquid crystal layer, the second insulating film having a compressive stress;
a third insulating film located between the second resin substrate and the liquid crystal layer;
a fourth insulating film located between the third insulating film and the liquid crystal layer, the fourth insulating film having a compressive stress; and
a plurality of spacers located between the first resin substrate and the second resin substrate, the plurality of spacers defining an interval between the first resin substrate and the second resin substrate.

2. The display device according to claim 1, wherein the compressive stress of each of the second insulating film and the fourth insulating film has an absolute value of 200 MPa or greater.

3. The display device according to claim 2, wherein the second insulating film and the fourth insulating film each have a thickness of 500 nm or greater.

4. The display device according to claim 1, wherein the first resin substrate and the second resin substrate are each a substrate containing polyimide.

5. A method for manufacturing a display device, comprising:
forming a flexible first resin substrate on a first support substrate;
forming a first insulating film on the first resin substrate by sputtering at room temperature;
forming a second insulating film having a compressive stress on the first insulating film;
forming a flexible second resin substrate on a second support substrate;
forming a third insulating film on the second resin substrate by sputtering at room temperature;
forming a fourth insulating film having a compressive stress on the third insulating film; and
assembling the first resin substrate and the second resin substrate with a plurality of spacers being located therebetween, the plurality of spacers defining an interval between the first resin substrate and the second resin substrate.

6. The method for manufacturing a display device according to claim 5, wherein the second insulating film and the fourth insulating film each having the compressive stress are formed under a condition that causes an absolute value of the compressive stress to be 200 MPa or greater.

7. The method for manufacturing a display device according to claim 6, wherein the second insulating film and the fourth insulating film each having the compressive stress are each formed to have a thickness of 500 nm or greater.

8. The method for manufacturing a display device according to claim 5, further comprising injecting a liquid crystal material into a space between the first resin substrate and the second resin substrate.

9. The method for manufacturing a display device according to claim further comprising peeling off the first support substrate and the second support substrate.

10. The method for manufacturing a display device according to claim 5, wherein the first resin substrate and the second resin substrate are each a substrate containing polyimide.
